(19) United States
(12) Patent Application Publication
(10) Pub. No.: US 2014/0297672 A1
(43) Pub. Date: Oct. 2, 2014

(54) CONTENT SERVICE METHOD AND SYSTEM

(71) Applicant: Samsung Electronics Co., Ltd., Suwon-si (KR)

(72) Inventors: Sungyoon SONG, Seoul (KR); Seungtaek PARK, Hwaseong-si (KR); Kyuho CHO, Suwon-si (KR); Sungyeol JIN, Yongin-si (KR)

(73) Assignee: Samsung Electronics Co., Ltd., Suwon-si (KR)

(21) Appl. No.: 14/225,901

(22) Filed: Mar. 26, 2014

(30) Foreign Application Priority Data
Apr. 1, 2013 (KR) 10-2013-0035022

(51) Int. Cl. G06F 17/30

(52) U.S. Cl. CPC G06F 17/30289
USPC 707/756

(57) ABSTRACT

A method and a system for registering content by a third party and recommending the registered content to a user of a user terminal are provided. The content service method includes receiving usage data from a user terminal, analyzing user's propensity according to the usage data, searching a trigger condition, corresponding to a result of the analysis, from a database module, and transmitting identification information of content, mapped to the searched trigger condition among the content stored in the database module, to the user terminal

### CROSS-REFERENCE TO RELATED APPLICATION(S)

This application claims the benefit under 35 U.S.C. §119(a) of a Korean patent application filed on Apr. 1, 2013 in the Korean Intellectual Property Office and assigned serial number 10-2013-0035022, the entire disclosure of which is hereby incorporated by reference.

### TECHNICAL FIELD

The present disclosure relates to a content service method and system. More particularly, the present disclosure relates to a method and a system for registering content by a third party and recommending the registered content to a user of a user terminal.

### BACKGROUND

Recently, a user terminal (e.g., a smart phone, a tablet Personal Computer (PC), etc.) may provide various functions to a user. In particular, the user terminal may be connected to a server through a network, and may download various contents from the server.

The user terminal receives content from the server through an Application Programming Interface (API) or an application provided by a company so that a user may use content of a content provider (e.g., a third party company).

In order for the user to use the content of the content provider, the user terminal should connect to the company's server or provide user information to the server. In particular, if the user desires to use the service of a plurality of companies, the user terminal must perform a connection procedure several times. Thus, there is a risk that the user information may be leaked, and it is inconvenient to use a content providing service.

The server provides a content list to the user terminal Users may use desired content through the list. Further, the type and the amount of the available content are now vastly increased, and thus, users now have difficulty in finding their desired content.

The server may register content from the content provider (e.g., a third party company such as NAVER, YAHOO!, etc.). However, the content provider also has difficulty in finding a suitable user (i.e., a main consumer) to provide the content to.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and a system for collecting a user data, and recommending a suitable content to a user based on the collected data.

Another aspect of the present disclosure further provides a method and a system for downloading content without a procedure of connecting to a content providing server.

Another aspect of the present disclosure further provides a method and a system for downloading content without providing user information to the content providing server.

Another aspect of the present disclosure further provides a method and a system for providing customized content to a user by selecting a trigger condition provided from a server to register when a third party company registers its content in the server.

In accordance with an aspect of the present disclosure, a method of operating a server is provided. The method includes receiving usage data from a user terminal, analyzing a user's propensity according to the usage data, searching a trigger condition, corresponding to a result of the analysis, from a database module, and transmitting identification information of content, mapped to the searched trigger condition, among a plurality of contents stored in the database module, to the user terminal

The method of operating a server may further include providing trigger conditions to the content providing server (e.g., a server of third party company), and storing a trigger condition, selected by the content providing server among the trigger conditions provided to the content providing server, which is mapped to the content received from the content providing server.

In accordance with another aspect of the present disclosure, a method of operating a user terminal is provided. The method includes collecting usage data related to a use of the user terminal, storing the usage data, transmitting a content request message including the usage data to an external device, receiving identification information of content from the external device, and displaying the identification information received from the external device.

In accordance with another aspect of the present disclosure, a content service system is provided. The content service system includes a first database module configured to store usage data received from a client, an analysis module configured to analyze a user's propensity according to the usage data stored in the first database module, and a content recommendation module configured to transmit a message, requesting a content corresponding to a result of the analysis, to a server in response to a request of the analysis module, and to transmit identification information of the content received from the preset server to the client in response to the transmitted message. The content service system may further include a content registration module configured to store the content and the trigger condition received from the content providing server in the second database module. The content registration module provides trigger conditions to the content providing server, and maps the trigger conditions, selected by the content providing server among the trigger conditions provided to the content providing server, to the content received from the content providing server to store in the second database module.

In accordance with yet another aspect of the present disclosure, a content recommendation server is provided. The server includes a context-awareness unit configured to receive, store, and analyze usage data, and a content management unit configured to receive and store information of content and corresponding trigger conditions from at least one content providing server. The context awareness unit recommends content from the at least one content providing server to a user according to the analysis and the trigger conditions.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of a block diagram of a user terminal according to an embodiment of the present disclosure;

FIG. 2 is a diagram illustrating a configuration of a network of a content service system according to an embodiment of the present disclosure;

FIG. 3 is a flowchart illustrating a content service method according to an embodiment of the present disclosure;

FIG. 4 is a diagram illustrating a usage data transmitted to a server from a user terminal according to an embodiment of the present disclosure; and

FIG. 5 is a diagram illustrating a usage data collected through a music player according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the present disclosure, a user terminal is a device having a computing resource, in particular, a wireless communication function for downloading data from a server. The user terminal may include, for example, a smart phone, a tablet Personal Computer (PC), a notebook PC, a digital camera, a computer monitor, a Personal Digital Assistant (PDA), a digital organizer, a desktop PC, a Portable Multimedia Player (PMP), a media player (e.g., a digital audio player), audio equipment, a wrist watch, a gaming device, home appliances (e.g., a refrigerator, TeleVision (TV), washing machine), and the like.

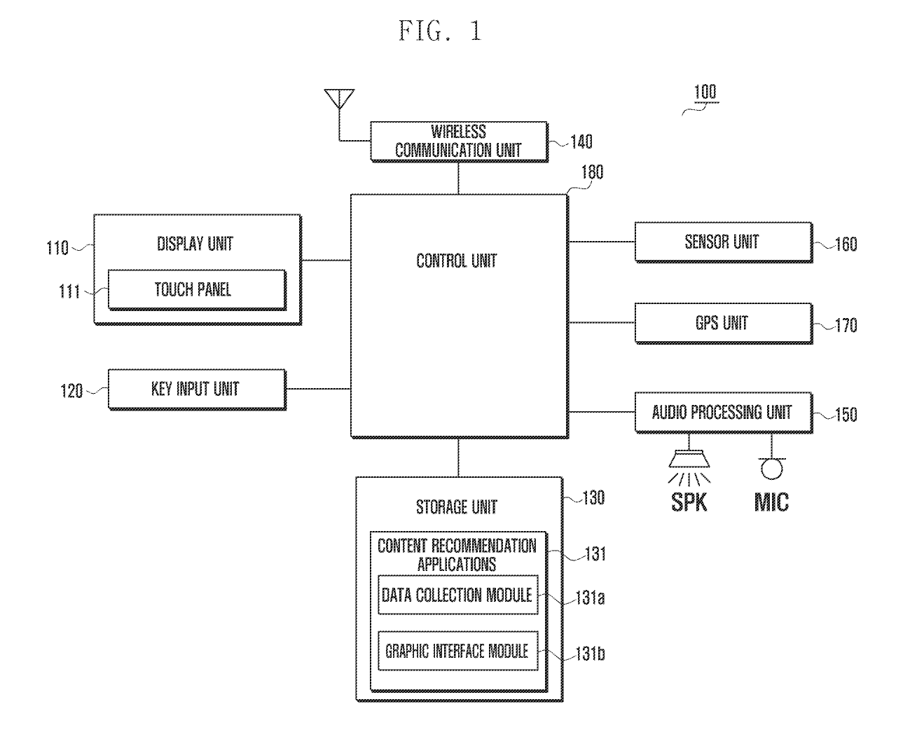

FIG. 1 is a block diagram illustrating a configuration of a block diagram of a user terminal according to an embodiment of the present disclosure.

Referring to FIG. 1, a user terminal 100 according to an embodiment of the present disclosure may include a display unit 110, a key input unit 120, a storage unit 130, a wireless communication unit 140, an audio processing unit 150, a speaker (SPK), a microphone (MIC), a sensor unit 160, a Global Positioning System (GPS) reception unit 170 and a controller 180.

The display unit 110 may display data on a screen under the control of the controller 180. That is, when the controller 180 processes (e.g., decodes) the data to store in a buffer, the display unit 110 may convert the data stored in the buffer into an analog signal and display the signal on the screen. The display unit 110 may be formed with a Liquid Crystal Display (LCD), an Active Matrix Organic Light Emitted Diode (AMOLED), a flexible display, or a transparent display.

A touch panel 111 may be a touch screen installed on a screen of a display unit 110. In more detail, the touch panel 111 may be implemented with an add-on type which is located on a screen of the display unit 110, an on-cell type, or an in-cell type inserted into the display unit 110. The touch panel 111 may generate a touch event in response to a touch gesture of a user for the screen, and Analog-to-Digital (AD) converts the touch events to transmit to the controller 160. The touch panel 111 may be a composite touch panel including a hand touch panel which detects a hand gesture or a pen touch panel which detects a pen gesture. Here, the hand touch panel may be implemented with a capacitive type. The hand touch panel may also be implemented with a resistive type, an infrared type, or an ultrasonic type. In addition, the hand touch panel may generate a touch event not only by a hand gesture but also by another object (e.g., an object of conductive material which may cause a variation in capacitance). The pen touch panel may be configured with an electromagnetic induction type. Accordingly, the pen touch panel may generate the touch event by a specially designed pen or stylus for forming or affecting a magnetic field.

The key input unit 120 may generate a key event related to a user setting and a function control of the user terminal 100 to transmit to the controller 160. The key event may include a power on/off event, a volume control event, a screen on/off event, a shutter event, or the like. The controller 160 may control the above-described configurations in response to such key events.

The storage unit 130 (secondary memory unit) may be a disk, a Random Access Memory (RAM), a Read Only Memory (ROM), a flash memory, and the like. The storage unit 130 may store data generated in the user terminal 100 or received from an external device (e.g., a server, a desktop PC, a tablet PC, etc.) through the wireless communication unit 140 under the control of the controller 180.

The storage unit 130 may store a booting program, at least one operating system, and applications. The operating system may serve as an interface between hardware and an application, and between applications, and manages a computer resource such as Central Processing Unit (CPU), a Graphics Processing Unit (GPU), a main memory, and the storage unit 130. The applications may be classified into an embedded application and a third party application. For example, the embedded application may include a web browser, an email program, an instant messenger, and the like. In particular, the storage unit 130 may store a content recommendation application 131. The content recommendation applications 131 may include a data collection module 131a and a graphic interface module 131b.

The data collection module 131a may include a routine for collecting data related to a behavior of using the application by the user. When a collection target application is a web browser, the behavior data may include a history (e.g., a cookie), a visit time, a number of visits, and the like. When the collection target application is a calendar, the behavior data may include a schedule.

When the collection target application is a gallery, the behavior data may include tag information tagging to an image (i.e., additional information related to a corresponding image). The file format of the tag information may be, for example, an Exchangeable image file format (Exif). For instance, the tag information may include identification information of an object in the image (e.g., a name, an address and a telephone number of a person, a name of object, etc.).

In addition, the tag information may further include a manufacturer (Maker) of a camera that has photographed a corresponding image, a camera model name, information of an image editor (software), a date of correcting a photo (Datetime), an Exif Version, a date of photographing a corresponding image (Shoot Datetime), a contrast, a resolution, a photographing program (EXPOSURE Program), a lens focal length (Focal Length), location information (e.g., GPS information), and the like.

When the collection target application is a music player, the behavior data may include an album name, a composer, a songwriter, a recording artist, a running time, a date of purchase, a provider of a music file, or the like. When the collection target application is a video player, the behavior data may include a running time, a date of purchase, a genre, a studio, the names of people who worked on the video such as a director, a producer, an actor, and the like.

The data collection module 131a may further include a routine of collecting data related to the user's context when the user uses the application. The context data may include a current time, sensing information (e.g., humidity, temperature, etc.) collected through a sensor unit 160, location information collected through a GPS reception unit 170, and the like. That is, the data collection module 131a may collect the context data corresponding to the behavior data when collecting the behavior data. For example, if the user uses a web browser, time information (e.g., a start point of accessing a web site is “15:00”), and location information (e.g., a web site is visited at 3 p.m. at “the company”) can be collected together with the visited web site information.

As described above, the data collection module 131a may include a routine for collecting usage data that tells a behavior of a terminal user related to the terminal in a specific context. In addition, the data collection module 131a may include a routine transmitting the usage data (e.g., including a behavior data and a context data) to a server. The usage data transmitted to the server may further include a user's profile (e.g., sex, age, name, etc.).

The graphic interface module 131b may include a routine of providing content recommendation information received from the server by a Graphic User Interface (GUI) feedback. That is, the graphic interface module 131b displays a content recommendation list. The content recommendation list can be classified by category. For example, the content recommendation list can be classified by recommended movie, recommended music, recommended travel product, recommended book, recommended training program, and recommended game. Such classified lists may be displayed separately. That is, one of the content recommendation lists may be displayed on a screen as a page (a.k.a. a card). For example, posters of each of recommended movies may be configured with a single page and be displayed. When a movie poster is selected by the user, detail information and a menu of a corresponding recommended movie may be displayed. Here, the menu may include, for example, a quick view button, a purchase button, a temporary save button, a wish list button, and the like.

Further, the content recommendation list may be configured as a single magazine view and be displayed. The magazine view (a.k.a. a tile view, a frame) may be divided into a plurality of compartments. For example, each of the compartments may display information related to a recommended movie, recommended music, a recommended travel destination, a recommended book, a recommended training program, a recommended game, and the like.

Meanwhile, the data collection module 131a and the graphic interface module 131b may be separate applications. The data collection module 131a may be a single module configuring an operating system rather than an application. In addition, the graphic interface module 131b may also be a single module configuring the operating system.

The wireless communication unit 140 performs a voice call, a video call, or data communication with an external device through a network under the control of the controller 180. The wireless communication unit 140 may include a Radio Frequency (RF) transmission unit which performs up-conversion and amplification of the frequency of the transmitted signal, and a radio frequency reception unit which performs low noise amplification and down-conversion of a received signal. In addition, the wireless communication unit 140 may include a mobile communication module such as an 3rd-Generation (3G) mobile communication module, a 3.5-Generation (3.5G) mobile communication module, or a 4th-Generation (4G) mobile communication module, etc., a digital broadcasting module such as Digital Multimedia Broadcasting (DMB), and a short distance communication module such as a WiFi module, a BLUETOOTH module, and a Near Field Communication (NFC) module.

The audio processing unit 150 may input and output an audio signal (e.g., voice data) for speech recognition, a voice recording, a digital recording, and a call in combination with the speaker and the microphone. The audio processing unit 150 may receive the audio signal from the controller 180, perform a Digital to Analog (D/A) conversion for the received audio signal, and amplify the converted audio signal to output through the speaker. The speaker may convert the audio signal received from the audio processing unit 150 into a sound wave to output. The microphone may convert the sound wave transmitted from a person or other sound sources into the audio signal. The audio processing unit 150 may perform an A/D conversion for the audio signal received from the microphone, and then transmit the converted digital signal to the controller 180.

The sensor unit 160 detects a physical quantity (e.g., humidity, a temperature, a quantity of light, a speed, an acceleration, an altitude, etc.) or a variation of the physical quantity, and generates detection information to transmit to the controller 180. For example, the sensor unit 160 may include various sensors such as a temperature sensor, a humidity sensor, an acceleration sensor, a gyro sensor, an illuminance sensor, an orientation sensor, a proximity sensor, a pressure sensor, and an image sensor.

The GPS reception unit 170 may receive a GPS signal including a transmission time at which three or more GPS satellites transmit, under the control of the controller 180, calculate a distance between the GPS reception unit (i.e., the user terminal 100) and each satellite by using a time difference between the transmission time and a reception time at which a GPS signal is received, calculate a position of the user terminal 100 (that is, a two-dimensional coordinate value (latitude/longitude)) by using the calculated distance information, and transmit the calculated position information to the controller 180. Here, such a calculation function may be performed in the controller 180, for example, an Application Processor (AP).

The controller 180 may control an overall operation of the user terminal 100 and a signal flow between the internal configurations of the user terminal 100, perform a function processing a data, and may control a power supply to the above configurations from a battery.

The controller 180 may include one or more CPU. Further, the controller 180 may include a GPU. The CPU and the GPU may be configured respectively by integrating two or more independent cores (e.g., quad-core) as one package which may be formed as a single Integrated Circuit (IC). That is, the CPUs may be integrated into a single multi-core processor. In addition, a plurality of GPUs may be integrated into a single multi-core processor. In addition, the CPU and the GPU may be integrated in one chip (i.e., a System on Chip (SoC)). In addition, the CPU and the GPU may be packaged with a multi-layer. The AP may include the CPU and the GPU. Furthermore, the AP may further include an Image Signal Processor (ISP).

The controller 180 may include a main memory, for example, a RAM. The main memory may store various programs loaded from the storage unit 130, for example, a booting program, an operating system, and an application. When power is supplied from a power supply such as a battery to the controller 180, the booting program may be first loaded into the main memory of the control program 180. Such a booting program may load the operating system into the main memory. The operating system may load applications into the main memory. The controller 180 (e.g., the AP) may access the main memory to decode program instructions (e.g., routines), and execute functions in accordance with the decoding result (e.g., a data collection, a display of a recommendation list, and the like). That is, various programs may be loaded into the main memory and operate as processes. In addition, the controller 180 may include a cache memory which temporarily stores data to be written on the storage unit 130 and temporarily stores data read from the storage unit 130.

The content recommendation application 131 may be loaded into the main memory by the operating system to operate as a process. That is, the processor of the controller 180 (e.g., an AP, CPU, GPU, Communication Processer (CP), etc.) may control the wireless communication unit 140 to collect behavior/context data, and transmit the behavior/context data to a server. In response to this, the server may store the behavior/context data, search content that matches the behavior/context data in a DataBase (DB) (a.k.a. repository), make a content recommendation list based on the search result, and transmit the content recommendation list to the user terminal 100. The controller 180 may receive the content recommendation list through the wireless communication unit 140, and control the display unit 110 to display the received content recommendation list as a card or a magazine view.

When the user terminal 100 is in the active mode, the process for the collection of usage data (e.g., including behavior/context data) may be performed in a real time. When the screen is turned off, the controller 190 may operate in a sleep mode. In this sleep mode, the process for the collection of behavior/context data may be terminated (e.g., deleted from main memory). Even if the screen is turned off, the controller 180 may continue to operate in the active mode. For example, if the function executed before the screen-off is a call, a music play, or the like, these functions may be continuously executed by the controller 180 even after the screen-off executes.

Meanwhile, the user terminal 100 may further include configurations that are not mentioned in the above, such as a vibration motor, accessories, and the like. Here, the accessory is a component of user terminal 100 which is separable from the user terminal 100, for example, a pen configured for touch.

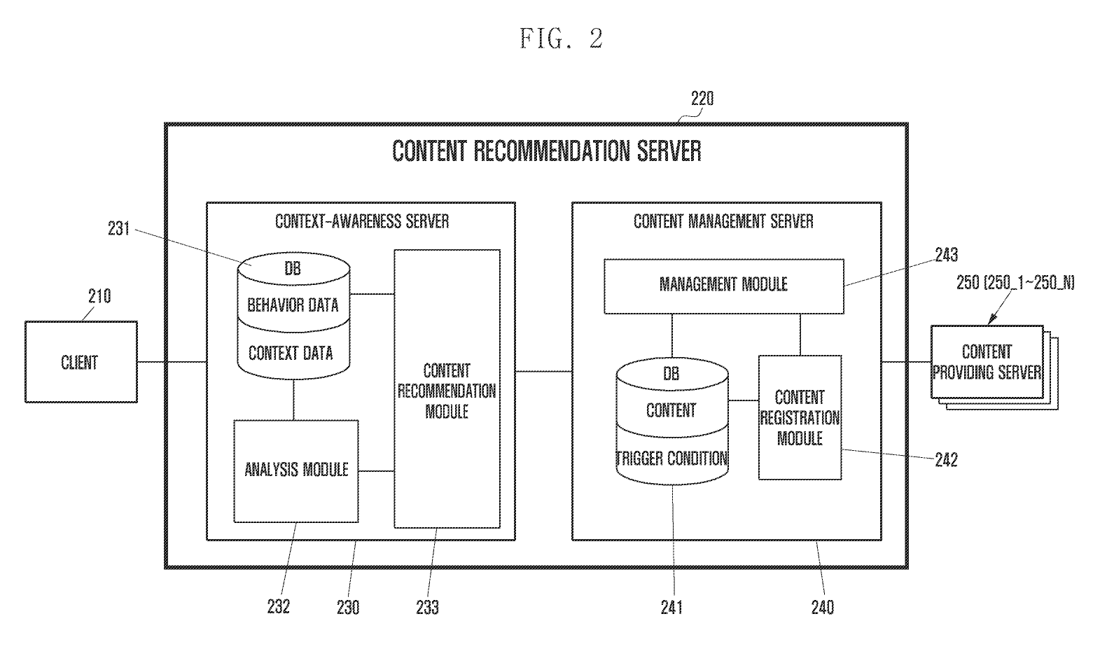

FIG. 2 is a diagram illustrating a configuration of a network of a content service system according to an embodiment of the present disclosure.

Referring to FIG. 2, the content service system may include a client 210, a content recommendation server 220, and at least one content providing server 250 (e.g., servers 250_1˜250_N) operated by a third party company. The content recommendation server 220 may include a context-awareness server 230 and a content management server 240.

A communication network may be disposed between the client 210 and the content recommendation server 220 and between the content recommendation server 220 and the content providing server 250. In addition, the communication network may also be disposed between the context-awareness server 230 and the content management server 240.

The communication network may form a communication channel between the servers, between the server and the client, and between the clients. The communication network may be configured with apparatuses supporting the mobile communication network (e.g., 3G, 4G) when the client 100 supports the mobile communication function. In addition, when the content recommendation server 200 is connected with the client 210 through a short distance wireless communication network (e.g., WiFi), the communication network may be configured with apparatuses supporting a corresponding wireless network. In addition, the communication network may further include a network apparatus for data transmission between heterogeneous networks. However, the network of the present disclosure is not limited to a specific communication method or communication apparatus. The communication network should be understood as any network in which transmission and reception of data can be performed, between the servers, between the server and the client, and between the clients.

The client 210 may be one of the above mentioned user terminals. In addition, the client 210 may have a configuration described with reference to FIG. 1, and may access the content recommendation server 220 (particularly, the context-awareness server 230) through the communication network. The client 210 may collect the usage data (e.g., including behavior/context data), and may transmit the usage data to the content recommendation server 220. In particular, when operating in the active mode, the client 210 may collect the usage data in real time, and may transmit a recommendation information request message including the usage data to the content recommendation server 220. In response to these requests, the content recommendation server 220 may transmit the recommendation information to the client 210. The client 210 may display the recommendation information with the above mentioned card or magazine view.

The context-awareness server 230 may include a first database module 231, an analysis module 232, and a content recommendation module 233. The context-awareness server 230 may receive the usage data (e.g., including behavior/context data) to store in the first database module 231.

The analysis module 232 may analyze the propensity of a user by using the usage data stored in the first database module 231, and transmit the result of analysis to the content recommendation module 233. A user's profile together with the usage data may be used for the analysis of data. The profile may be a profile transmitted to the content recommendation server 220 by a corresponding client. Alternatively, the profile may be information input when the user connects to the content recommendation server 220. The result of analysis may include data indicating the propensity of the user by category. For example, the result of analysis may be as indicated in Table 1 by category.

TABLE 1

| Category | Propensity | Recent interest |
|---|---|---|
| Movie | Action | Camping Gear |
| Music | Ballad | |
| Travel | Camping | |
| Books | Fantasy | |
| Education | English | |
| Game | Starcraft | |
| Sports | Basketball | |

The result of the analysis may include the user's profile (e.g., sex, age, etc.). That is, the analysis module 232 may analyze the user's propensity by using the usage data stored in the first database module 231, and may transmit the user's profile together with the result of analysis to the content recommendation module 233.

The content recommendation module 233 may transmit a message requesting a content (or identification information thereof) matched to the analysis result (profile may be included) to the content management server 240. For instance, the content recommendation module 233 may transmit a request message including data indicating the user's propensity by category and corresponding user's profile to the content management server 240. In addition, the content recommendation module 233 may transmit a request message including data indicating a recent interest and corresponding user's profile to the content management server 240.

In response to this request message, the content management server 240 may transmit content or identification information of the content to the content recommendation module 233. The content recommendation module 233 may transmit recommendation information including the identification information to the client 210.

For example, if the profile and the result of the analysis are “a 30-39 year old (profile) man (profile) who likes Manchester United Football Club (result of analysis)”, a recommendation message recommending a Manchester United game video (content) may be transmitted to the client 210. If the profile and the result of the analysis are “a woman (profile) aged 20-29 (profile) who plans to visit Gangnam station (result of analysis) this evening (result of analysis)”, a recommendation message including information of a restaurant which women (profile) in their twenties are known to prefer near Gangnam station may be transmitted to the client 210.

The content management server 240 may include a second database module 241, a content registration module 242 and a management module 243.

The content registration module 242 may receive content from the content providing servers (e.g., 250_1˜250_N) and store into the second database module 241. The second database module 241 may store a content and a trigger condition mapped to the content. The trigger condition may be a condition for determining a major consumer of content.

In addition, the content registration module 242 may provide the trigger condition to the content providing servers 250_1˜250_N. Accordingly, the content providing servers 250_1˜250_N may select the trigger condition of corresponding content, when the content is stored in the second database module 241. The content registration module 242 may map the selected trigger condition to corresponding content and store into the second database module 241.

The second database module 241 may receive a request message from the content recommendation module 233, and search the trigger condition corresponding to the data included in the request message. The second database module 241 may transmit the content mapped to the searched trigger condition or the identification information of the content (e.g., name of content, thumbnail) to the content recommendation module 233.

The management module 243 may manage the second database module 241 and the content registration module 242. In particular, the management module 243 enables an administrator to manage the trigger condition. To this end, the management module 243 may include a user interface module such as a touch screen, a keypad, etc. In addition, the management module 243 may further include a communications module for communicating with an administrator terminal The communication module may be configured with a device supporting mobile communication (e.g., 4G), short distance wireless communication (e.g., Wi-Fi), and the like.

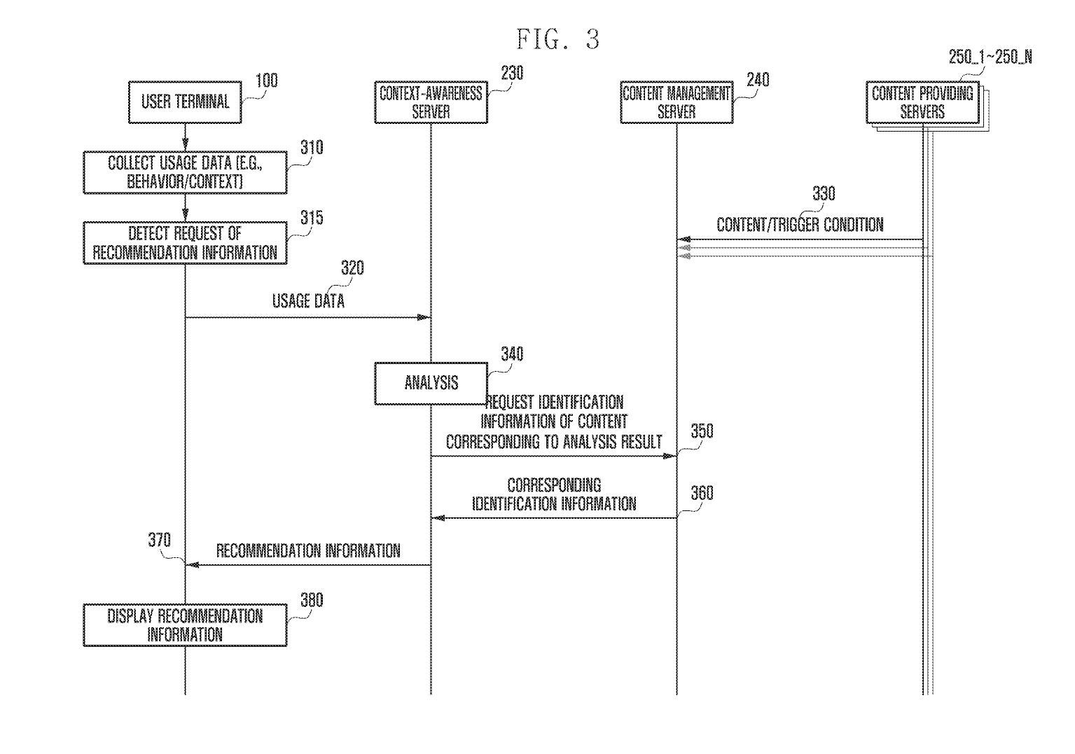

FIG. 3 is a flowchart illustrating a content service method according to an embodiment of the present disclosure.

Referring to FIG. 3, at operation 310, when operating in an active mode, the user terminal 100 may collect the usage data (e.g., including behavior/context data) in real time and store the collected usage data in the memory (e.g., the storage unit 130 or the main memory of the controller 180). If usage data must be deleted or is configured to expire after a threshold time period, a first stored usage data may be deleted first. For example, the usage data stored before one week may be deleted first.

The user terminal 100 may detect an event requesting recommendation information at operation 315. As an example, the display unit 110 may display an icon indicating a content recommendation application under the control of the controller 180. When the user selects the icon by a touch input means, the touch panel 111 may detect this icon selection, and may generate an event to transmit to the controller 180. The controller 180 may detect the reception of the event from the touch panel 110, and may execute the content recommendation application in response to the event. As mentioned above, the user terminal 100, i.e., the controller 180 may determine the selection of the touch input means for the icon indicating the content recommendation application as “a request for recommendation information.”

The user terminal 100 may transmit the usage data to the context-awareness server 230 in response to the request of recommendation information, at operation 320. In this case, either 1) all stored usage data may be transmitted, or 2) only some of all stored usage data may be transmitted according to a preset condition. For example, 2-1) the usage data stored later among all usage data (e.g., a full day has not elapsed since being stored) may be transmitted; 2-2) some usage data among the categories in Table 1 (e.g., usage data related with movie, usage data related with music) may be transmitted; or 2-3) the usage data corresponding to a specific application (e.g., a web browser) among all usage data may be transmitted. The usage data may be received from the user terminal 100 automatically. In other words, the user terminal 100 may transmit the usage data to the context awareness server 230 without a request from the user.

The above conditions may be optionally configured by a user. For example, the display unit 110 may display an environment setting image related to the content recommendation application under the control of the controller 180. The user may set a condition for recommendation through the environment setting image.

The content management server 240 may receive the content and the trigger condition from the content providing servers 250_1˜250_N and store into the second database module 241, at operation 330. This operation may be performed at any time, and is not dependent on operations 310-320 above. The context awareness server 230 may receive the usage from the user terminal 100 and store the usage data. The context awareness server 230 may analyze the propensity of a user by using the stored usage data at operation 340.

The context awareness server 230 may transmit the request message including the result of the analysis to the content management server 240 at operation 350. The content management server 240 may search the trigger condition corresponding to the result of the analysis from the second database module 241 in response to the request of the context awareness server 230, and transmit the identification information of content mapped to the searched trigger condition to the context awareness server 230 at operation 360.

The context awareness server 230 may receive the identification information, and transmit the recommendation information including the identification information to the user terminal 100 at operation 370.

The user terminal 100 may receive the recommendation information, at operation 370, and may display the recommendation information as a card or a magazine view at operation 380.

The above mentioned operation 315 may be omitted. That is, the user terminal 100 may collect the usage data, and transmit the usage data periodically (e.g., every hour) to the context awareness server 230, regardless of the user's request.

An example of omitting the operation 315 is as follows.

When a power is supplied to the display unit 110, the display unit 110 may display a lock screen. When unlock information is detected in the state in which the lock screen is displayed, the controller 180 may unlock a screen. The display unit 110 may display a home screen instead of the lock screen under the control of the controller 180. The home screen of the user terminal 100 may be configured with an icon for the execution of the application, an application execution image, and the like. When the execution image corresponding to the content recommendation application is included in the home screen, the above-described operation 315 may be omitted. Here, the execution image may include the recommendation information. That is, the execution image may be displayed in the form of a card or magazine view.

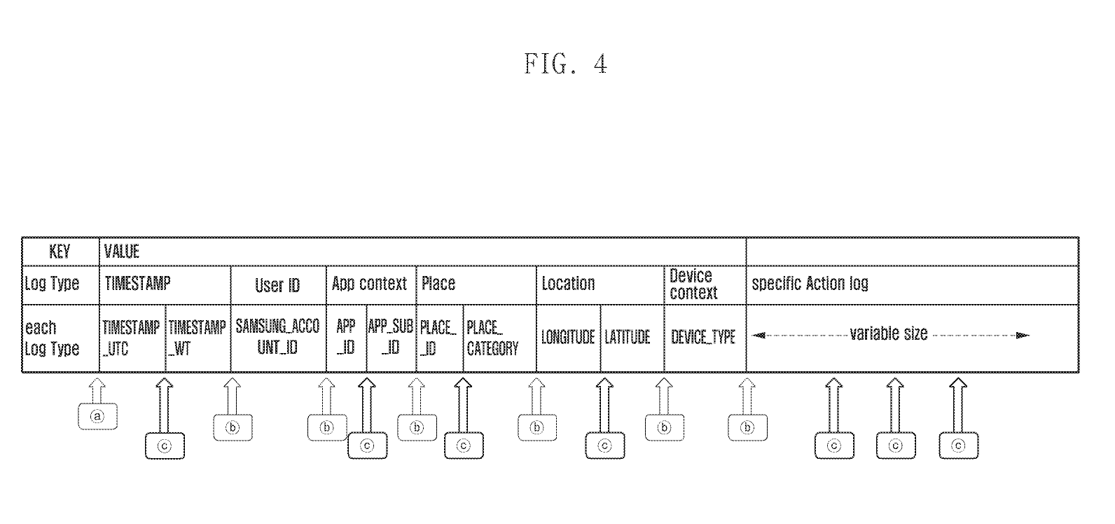

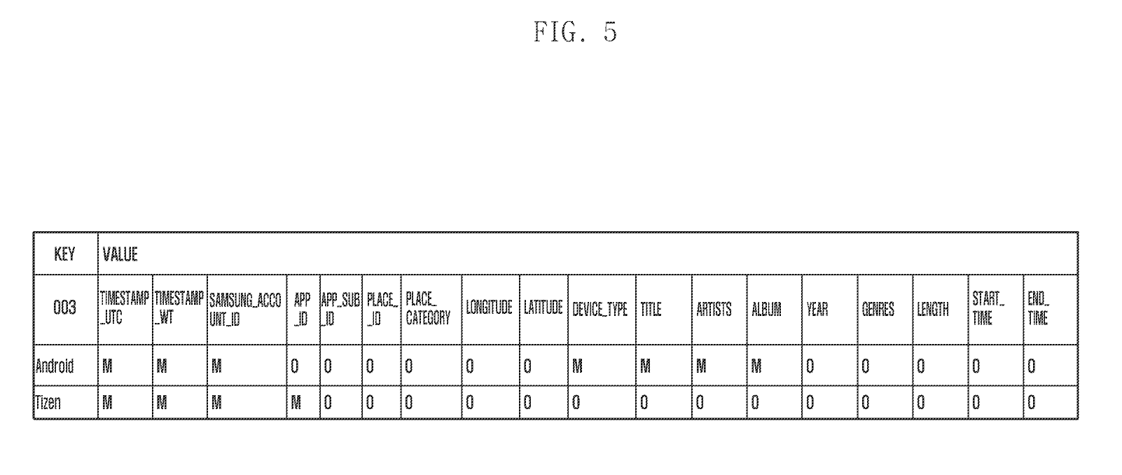

FIG. 4 is a diagram illustrating usage data transmitted to a server from a user terminal according to an embodiment of the present disclosure. FIG. 5 is a diagram illustrating usage data collected through a music player according to an embodiment of the present disclosure.

Referring to FIG. 4, the user terminal 100 may collect the usage data, and transmit the usage data to the content recommendation server 220. As shown in FIG. 4, the usage data may include a log type, a time stamp, a user IDentification (ID), an application context, a place type, a geographic location, a device context, and a specific action log. A delimiter may be inserted between each item. Accordingly, the usage data may be configured with a single string, and transmitted to the server 220. For example, the string may be, hierarchically, as follows.

Hierarchy

Log Typeâ

timestamp_utcĉtimestamp_wt\hat{b}

User IDE\hat{b}

app_IDĉapp_sub_ID\hat{b}

place_IDsĉplace_namesĉplace_categories\hat{b}

longitudeĉlatitude\hat{b}

device_type\hat{b}

specific_log\hat{b}

In the above, â, \hat{b}, and ĉ are the delimiters. For example, the value of â may be \u0001, the value of \hat{b} may be \u0002, and the value of ĉ may be \u0003.

A log type may have a value as in Table 2 according to an application.

TABLE 2

| log type | value |
|---|---|
| use_app | 001 |
| magage_app | 002 |
| play_music | 003 |
| read_book | 004 |
| browse_web | 005 |
| exchange_call | 006 |
| exchange_message | 007 |
| click_content | 008 |
| expose_content | 009 |

A place may have a value like Table 3 according to a type.

TABLE 3

| place_type | value |
|---|---|
| home | 001 |
| office | 002 |
| car | 003 |
| others | 004 |

If the application of the usage data is a music player, as shown in FIG. 5, a specific action log may include a title, an artist, an album, a year, a genre, a length, a start time, an end time, and the like. Each item of the specific action log may be divided by the delimiter ĉ.

The foregoing method of the present disclosure may be implemented in a program command form executable by various computer means and be recorded in a non-transitory computer readable recording medium. In this case, the non-transitory computer readable recording medium may include a program command, a data file, and a data structure individually or a combination thereof The program command recorded in a recording medium may be specially designed or configured for the present disclosure or be known to a person having ordinary skill in a computer software field to be used. The non-transitory computer readable recording medium includes magnetic media such as hard disk, floppy disk, or magnetic tape, optical media such as Compact Disc (CD) Read Only Memory (CD-ROM) or Digital Versatile Disc (DVD), magneto-optical media such as a floptical disk, and a hardware device such as ROM, Random Access Memory (RAM), or flash memory, for storing and executing program commands. Further, the program command includes a machine language code created by a compiler and a high-level language code executable by a computer using an interpreter. The foregoing hardware device may be configured to be operated according to at least one software module to perform an operation of the present disclosure.

As described above, the method and the system of the present disclosure may address the above problems. In particular, the present disclosure provides a method and a system for collecting user data and recommending a suitable content to a user based on the collected data. In addition, the present disclosure provides a method and a system for downloading content without requiring a procedure of connecting to a content providing server. In addition, the present disclosure provides a method and a system for downloading content without providing user information to the content providing server. In addition, the present disclosure provides a method and a system for providing customized content to a user by selecting a trigger condition provided from a server to register when a third party company registers its content in the server.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of operating a server, the method comprising:
receiving a usage data from a user terminal;
analyzing a user's propensity according to the usage data;
searching a trigger condition, corresponding to a result of the analysis, from a database module; and
transmitting identification information of content, mapped to the searched trigger condition from among contents stored in the database module, to the user terminal

2. The method of claim 1, further comprising receiving at least one content and a trigger condition from a content providing server and storing the received content and trigger condition into the database module.

3. The method of claim 2, wherein the storing of the received content and trigger condition into the database module comprises:
providing trigger conditions to the content providing server; and
storing a trigger condition, selected by the content providing server from among the trigger conditions provided to the content providing server, which is mapped to the content received from the content providing server.

4. The method of claim 1, wherein the receiving of the usage data from the user terminal comprises receiving data related to the user's usage of an application.

5. The method of claim 4, wherein the receiving of the usage data from the user terminal comprises receiving data related to a context of the user together with the data related to user's application usage from the user terminal

6. The method of claim 5, wherein the data related to the context of the user comprises information collected through at least one of a sensor unit and a Global Positioning System (GPS) unit of the user terminal.

7. The method of claim 1, wherein the searching of the trigger condition comprises searching a trigger condition corresponding to a user's profile and a result of the analysis.

8. A method of operating a user terminal, the method comprising:
collecting a usage data related to a use of the user terminal;
storing the usage data;
transmitting a content request message including the usage data to an external device;
receiving identification information of content from the external device; and
displaying the identification information received from the external device.

9. The method of claim 8, wherein the collecting of the usage data comprises collecting data related to a user's usage of an application.

10. The method of claim 9, wherein the collecting of the usage data comprises collecting data related to a context of the user together with the data related to user's application usage.

11. The method of claim 10, wherein the data related to the context of the user comprises information collected through at least one of a sensor unit and a Global Positioning System (GPS) unit of the user terminal.

12. A content service system comprising:
a first database module configured to store usage data received from a client;
an analysis module configured to analyze a user's propensity according to the usage data stored in the first database module; and
a content recommendation module configured to transmit a message, requesting a content corresponding to a result of the analysis, to a server in response to a request of the analysis module, and to transmit identification information of the content received from the server to the client in response to the transmitted message.

13. The content service system of claim 12, further comprising a second database module configured to store trigger conditions and contents which are mapped to the trigger conditions respectively, to receive a request message including a result of the analysis from the content recommendation module, to search a trigger condition corresponding to the result of the analysis from among the stored trigger conditions, and to transmit identification information of a content, mapped to the searched trigger condition, from among the stored contents to the content recommendation module.

14. The content service system of claim 13, further comprising a content registration module to store a content and a trigger condition, received from the content providing server, into the second database module.

15. The content service system of claim 14, wherein the content registration module provides trigger conditions to the content providing server and maps a trigger condition, selected by the content providing server from among the trigger conditions provided to the content providing server, to the content received from the content providing server to store into the second database module.

16. The content service system of claim 13, wherein the second database module searches a trigger condition corresponding to a user's profile and a result of the analysis from among the stored trigger conditions.

17. The content service system of claim 12, wherein the first database module receives data related to user's usage of an application from the client.

18. The content service system of claim 17, wherein the first database module receives data related to a context of the user together with the data related to user's application usage from the client.

19. The content service system of claim 18, wherein the data related to the context of the user comprises information collected through at least one of a sensor unit and a Global Positioning System (GPS) unit of the user terminal
